(19) United States
(12) Patent Application Publication
(10) Pub. No.: US 2018/0082345 A1
(43) Pub. Date: Mar. 22, 2018

(54) METHOD AND DEVICE FOR PROCESSING INFORMATION AND DETERMINING INVOICE INFORMATION

(71) Applicant: ALIBABA GROUP HOLDING LIMITED, Grand Cayman (KY)

(72) Inventors: HANBING PAN, HANGZHOU (CN); SONGTAO AN, HANGZHOU (CN); QINGGANG LI, HANGZHOU (CN)

(21) Appl. No.: 15/824,741

(22) Filed: Nov. 28, 2017

Related U.S. Application Data
(63) Continuation of application No. PCT/CN2016/083592, filed on May 27, 2016.

(30) Foreign Application Priority Data
Jun. 4, 2015 (CN) 201510303430.5

(51) Int. Cl. G06Q 30/04; G06Q 20/10; G06Q 40/00; G06F 7/08; G06F 17/30

(52) U.S. Cl. CPC G06Q 30/04; G06Q 20/102; G06F 17/30707; G06F 7/08; G06Q 40/12

(57) ABSTRACT

A method and a device for processing information and determining invoice information to achieve a minimal number of product types on each invoice while ensuring a minimal number of invoices, thus facilitating a user to check product items against an invoice and improving work efficiency. The invoice information determining method comprises determining information of at least one product, wherein the information of each product comprises a monetary amount and a name of the product, grouping the information of all products according to the value of the monetary amount of each product and a preset threshold value to obtain a first group of product information and a second group of product information, for the information of each product in the first group of product information, generating at least one piece of invoice information according to the value of the monetary amount of the product and the preset threshold value, and for the second group of product information, generating at least one piece of invoice information according to the preset threshold value and by utilizing information of a plurality of products in the second group of product information.

### CROSS-REFERENCE TO RELATED APPLICATIONS

The present application is a continuation application of International Patent Application No. PCT/CN2016/083592, filed May 27, 2016, which is based on and claims priority to Chinese patent application No. 201510303430.5 filed on Jun. 4, 2015 and entitled “Method and Device for Processing Information and Determining Invoice Information.” Both are incorporated herein by reference in their entirety.

### TECHNICAL FIELD

The present disclosure relates to the field of electrical technologies, and in particular to a method and a device for processing information and determining invoice information.

### BACKGROUND

In some businesses, different clients have different invoicing qualifications. In situations that each individual invoice is subject to a maximum invoicing amount, a minimal number of invoices and a minimal number of product types on each invoice are desired in the case where a client places an order involving a plurality of products, so as to reduce the waste of invoices for the client and make it more convenient for the client to check product items against invoices.

At present, commercially available invoicing solutions are relatively simple, all types of products are divided according to the monetary amount of individual invoices, which can meet the requirement of a minimal number of invoices, but cannot meet the requirement of a minimal number of product types on a single invoice, making it complex for a client to perform subsequent check operations.

For example, a client A has an invoicing qualification to issue individual invoices with a face value up to 10,000, and one order comprises 3 products that are A (28,000), B (10,000), and C (5,000), respectively. Then, the results from a division algorithm according to the prior art are shown in Table 1 below:

TABLE 1

| Invoice serial number | Product name and amount |
|---|---|
| 1 | Product A: 10,000; |
| 2 | Product A: 10,000; |
| 3 | Product A: 8,000; |
| | Product B: 2,000; |
| 4 | Product B: 8,000; |
| | Product C: 2,000; |
| 5 | Product C: 3,000; |

It can be seen that the prior art is unable to achieve a minimal number of product types on each invoice. In the process that a client checks product items against an invoice, individual invoices have too many product types, leading to a relatively low work efficiency.

### SUMMARY

Embodiments of the present disclosure provide a method and a device for processing information and determining invoice information to have a minimal number of product types on each invoice while ensuring a minimal number of invoices, thus facilitating a user to check product items against an invoice and improving work efficiency.

According to some embodiments, an information processing method comprises:

determining information of at least one object, wherein the information of each object comprises first attribute information and second attribute information of the object;

grouping the information of all the objects according to the value of the first attribute information of each object and a preset threshold value to obtain a first group of object information and a second group of object information;

for the information of each object in the first group of object information, generating at least one piece of target information according to the value of the first attribute information of the object and the preset threshold value, wherein the target information comprises the first attribute information having a value of the preset threshold value and the second attribute information of the object, and when a remainder returned by a modulo operation after division of the value of the first attribute information of the object by the preset threshold value is not zero, using the obtained remainder as the value of the first attribute information of the object, and transferring the information of the object into the second group of object information;

for the second group of object information, generating at least one piece of target information according to the preset threshold value and by utilizing the information of a plurality of objects in the second group of object information, wherein each piece of target information comprises the first attribute information and the second attribute information of the objects in the second group of object information, and the sum of the first attribute information in each piece of target information is equal to or less than the preset threshold value.

The information processing method according to embodiments of the present disclosure groups the information of all the objects according to the value of the first attribute information of each object and a preset threshold value to obtain a first group of object information and a second group of object information; for the information of each object in the first group of object information, generates at least one piece of target information according to the value of the first attribute information of the object and the preset threshold value, wherein the target information comprises the first attribute information having a value of the preset threshold value and the second attribute information of the object, and when a remainder returned by a modulo operation after division of the value of the first attribute information of the object by the preset threshold value is not zero, uses the obtained remainder as the value of the first attribute information of the object, and transfers the information of the object into the second group of object information; for the second group of object information, generates at least one piece of target information according to the preset threshold value and by utilizing the information of a plurality of objects in the second group of object information, wherein each piece of target information comprises the first attribute information and the second attribute information of the objects in the second group of object information, and the sum of the first attribute information in each piece of target information is equal to or less than the preset threshold value. Here, the object is, for example, a product; the first attribute information is, for example, a monetary amount of the product; and the second attribute information is, for example, a name of the product. The first group of object information is, for example, information of products with a monetary amount more than 10,000; or the first group of object information is, for example, information of products with a monetary amount less than 10,000. The target information is, for example, information of an invoice. As a result, each invoice has a minimal number of product types while a minimal number of invoices is ensured, thus facilitating a user to check product items against an invoice and improving work efficiency.

Optionally, the generating at least one piece of target information according to the preset threshold value and by utilizing the information of a plurality of objects in the second group of object information comprises:

(i) if the sum of values of the first attribute information of all objects in the second group of object information is greater than the preset threshold value, sequentially reading the value of the first attribute information of each object in the second group of object information, and performing current accumulation;

(ii) when the obtained sum reaches the preset threshold value, generating target information corresponding to the current accumulation operation, the target information comprising the first attribute information and the second attribute information of the plurality of objects that participate in the current accumulation operation, and the sum of the first attribute information of the plurality of objects that participate in the current accumulation operation being equal to the preset threshold value;

(iii) when the obtained sum is greater than the preset threshold value, dividing the value of the first attribute information of the last object in the current accumulation operation, one part of which is used in the current accumulation operation as the value of the first attribute information of the last object in the current accumulation operation, such that the obtained sum reaches the preset threshold value, and the other part of which is used as the value of the first attribute information of the last accumulated object to participate in the next accumulation; and

(iv) repeating (ii) and (iii) until the value of the first attribute information of each object in the second group of object information has been accumulated, wherein the sum of values of the first attribute information of the objects comprised in the target information corresponding to the last accumulation operation is less than or equal to the preset threshold value;

(v) if the sum of values of the first attribute information of all objects in the second group of object information is less than or equal to the preset threshold value, generating a piece of target information that comprises the first attribute information and the second attribute information of each object in the second group of object information.

Optionally, the grouping the information of all the objects according to the value of the first attribute information of each object and a preset threshold value to obtain a first group of object information and a second group of object information comprises:

sorting the information of all the objects according to a descending order of the value of the first attribute information of each object, and grouping the information of all the objects according to the sorting result and a preset threshold value to obtain a first group of object information and a second group of object information, wherein the value of the first attribute information of each object in the first group of object information is greater than or equal to the preset threshold value, and the value of the first attribute information of each object in the second group of object information is less than the preset threshold value.

An invoice information determining method according to embodiments of the present invention comprises:

determining information of at least one product, wherein the information of each product comprises a monetary amount and a name of the product;

grouping the information of all the products according to the value of the monetary amount of each product and a preset threshold value to obtain a first group of product information and a second group of product information;

for the information of each product in the first group of product information, generating at least one piece of invoice information according to the value of the monetary amount of the product and the preset threshold value, wherein the invoice information comprises the monetary amount having a value of the preset threshold value and the name of the product, and when a remainder returned by a modulo operation after division of the value of the monetary amount of the product by the preset threshold value is not zero, using the obtained remainder as the value of the monetary amount of the product, and transferring the information of the product into the second group of product information;

for the second group of product information, generating at least one piece of invoice information according to the preset threshold value and by utilizing information of a plurality of products in the second group of product information, wherein each piece of invoice information comprises monetary amounts and names of the products in the second group of product information, and the sum of the monetary amounts in each piece of invoice information is equal to or less than the preset threshold value.

The method according to embodiments of the present disclosure groups the information of all the products according to the value of the monetary amount of each product and a preset threshold value to obtain a first group of product information and a second group of product information; for the information of each product in the first group of product information, generates at least one piece of invoice information according to the value of the monetary amount of the product and the preset threshold value, wherein the invoice information comprises the monetary amount having a value of the preset threshold value and the name of the product, and when a remainder returned by a modulo operation after division of the value of the monetary amount of the product by the preset threshold value is not zero, uses the obtained remainder as the value of the monetary amount of the product, and transfers the information of the product into the second group of product information; for the second group of product information, generating at least one piece of invoice information according to the preset threshold value and by utilizing information of a plurality of products in the second group of product information, wherein each piece of invoice information comprises monetary amounts and names of the plurality of products in the second group of product information, and the sum of the monetary amounts of the plurality of products is equal to or less than the preset threshold value. As a result, each invoice has a minimal number of product types while a minimal number of invoices is ensured, thus facilitating a user to check product items against an invoice and improving work efficiency.

Optionally, the generating at least one piece of invoice information according to the preset threshold value and by utilizing information of a plurality of products in the second group of product information comprises:

(i) if the sum of the monetary amounts of all products in the second group of product information is greater than the preset threshold value, sequentially reading the value of the monetary amount of each product in the second group of product information, and performing current accumulation;

(ii) when the obtained sum reaches the preset threshold value, generating invoice information corresponding to the current accumulation operation, the invoice information comprising monetary amounts and names of the plurality of products that participate in the current accumulation operation, and the sum of the monetary amounts of the plurality of products being equal to the preset threshold value;

(iii) when the obtained sum is greater than the preset threshold value, dividing the value of the monetary amount of the last product in the current accumulation operation, one part of which is used in the current accumulation operation, such that the obtained sum reaches the preset threshold value, and the other part of which is used as the value of the monetary amount of the last accumulated product to participate in the next accumulation; and

(iv) repeating (ii) and (iii) until the value of the monetary amount of each product in the second group of product information has been accumulated, wherein the value of the monetary amount comprised in the invoice information corresponding to the last accumulation operation is less than or equal to the preset threshold value;

(v) if the sum of the monetary amounts of all products in the second group of product information is less than or equal to the preset threshold value, generating a piece of invoice information that comprises the monetary amount and the name of each product in the second group of product information.

Optionally, the grouping the information of all the products according to the value of the monetary amount of each product and a preset threshold value to obtain a first group of product information and a second group of product information comprises:

sorting the information of all the products according to a descending order of the monetary amount of each product, and grouping the information of all the products according to the sorting result and a preset threshold value to obtain a first group of product information and a second group of product information, wherein the monetary amount of each product in the first group of product information is greater than or equal to the preset threshold value, and the monetary amount of each product in the second group of product information is less than the preset threshold value.

An information processing device according to embodiments of the present invention comprises:

a first unit configured to determine information of at least one object, wherein the information of each object comprises first attribute information and second attribute information of the object;

a second unit configured to group the information of all the objects according to the value of the first attribute information of each object and a preset threshold value to obtain a first group of object information and a second group of object information;

a third unit configured to, for the information of each object in the first group of object information, generate at least one piece of target information according to the value of the first attribute information of the object and the preset threshold value, wherein the target information comprises the first attribute information having a value of the preset threshold value and the second attribute information of the object, and when a remainder returned by a modulo operation after division of the value of the first attribute information of the object by the preset threshold value is not zero, use the obtained remainder as the value of the first attribute information of the object, and transfer the information of the object into the second group of object information;

a fourth unit configured to, for the second group of object information, generate at least one piece of target information according to the preset threshold value and by utilizing the information of a plurality of objects in the second group of object information, wherein each piece of target information comprises the first attribute information and the second attribute information of the objects in the second group of object information, and the sum of the first attribute information in each piece of target information is equal to or less than the preset threshold value.

Optionally, the fourth unit that generates at least one piece of target information according to the preset threshold value and by utilizing the information of a plurality of objects in the second group of object information is configured to:

(i) if the sum of values of the first attribute information of all objects in the second group of object information is greater than the preset threshold value, sequentially read the value of the first attribute information of each object in the second group of object information, and perform current accumulation;

(ii) when the obtained sum is greater than or equal to the preset threshold value, generate target information corresponding to the current accumulation operation, the target information comprising the first attribute information and the second attribute information of the plurality of objects that participate in the current accumulation operation, and the sum of the first attribute information of the plurality of objects that participate in the current accumulation operation being equal to the preset threshold value;

(iii) when the obtained sum is greater than the preset threshold value, divide the value of the first attribute information of the last object in the current accumulation operation, one part of which is used in the current accumulation operation as the value of the first attribute information of the last object in the current accumulation operation, such that the obtained sum reaches the preset threshold value, and the other part of which is used as the value of the first attribute information of the last accumulated object to participate in the next accumulation; and

(iv) repeat (ii) and (iii) until the value of the first attribute information of each object in the second group of object information has been accumulated; here, the sum of values of the first attribute information of the objects comprised in the target information corresponding to the last accumulation operation is less than or equal to the preset threshold value;

(v) if the sum of values of the first attribute information of all objects in the second group of object information is less than or equal to the preset threshold value, generate a piece of target information that comprises the first attribute information and the second attribute information of each object in the second group of object information.

Optionally, the second unit is configured to:

sort the information of all the objects according to a descending order of the value of the first attribute information of each object, and group the information of all the objects according to the sorting result and a preset threshold value to obtain a first group of object information and a second group of object information, wherein the value of the first attribute information of each object in the first group of object information is greater than or equal to the preset threshold value, and the value of the first attribute information of each object in the second group of object information is less than the preset threshold value.

An invoice information determining device according to embodiments of the present invention comprises:

a product information determining unit configured to determine information of at least one product, wherein the information of each product comprises a monetary amount and a name of the product;

a grouping unit configured to group the information of all the products according to the value of the monetary amount of each product and a preset threshold value to obtain a first group of product information and a second group of product information;

a first invoice information generating unit configured to, for the information of each product in the first group of product information, generate at least one piece of invoice information according to the value of the monetary amount of the product and the preset threshold value, wherein the invoice information comprises the monetary amount having a value of the preset threshold value and the name of the product, and when a remainder returned by a modulo operation after division of the value of the monetary amount of the product by the preset threshold value is not zero, use the obtained remainder as the value of the monetary amount of the product, and transfer the information of the product into the second group of product information;

a second invoice information generating unit configured to, for the second group of product information, generate at least one piece of invoice information according to the preset threshold value and by utilizing information of a plurality of products in the second group of product information, wherein each piece of invoice information comprises monetary amounts and names of the products in the second group of product information, and the sum of the monetary amounts in each piece of invoice information is equal to or less than the preset threshold value.

Optionally, the second invoice information generating unit that generates at least one piece of invoice information according to the preset threshold value and by utilizing information of a plurality of products in the second group of product information is specifically configured to:

(i) if the sum of the monetary amounts of all products in the second group of product information is greater than the preset threshold value, sequentially read the value of the monetary amount of each product in the second group of product information, and perform current accumulation;

(ii) when the obtained sum is greater than or equal to the preset threshold value, generate invoice information corresponding to the current accumulation operation, the invoice information comprising monetary amounts and names of the plurality of products that participate in the current accumulation operation, and the sum of the monetary amounts of the plurality of products being equal to the preset threshold value;

(iii) when the obtained sum is greater than the preset threshold value, divide the value of the monetary amount of the last product in the current accumulation operation, one part of which is used in the current accumulation operation, such that the obtained sum reaches the preset threshold value, and the other part of which is used as the value of the monetary amount of the last accumulated product to participate in the next accumulation; and

(iv) repeat (ii) and (iii) until the value of the monetary amount of each product in the second group of product information has been accumulated; here, the value of the monetary amount comprised in the invoice information corresponding to the last accumulation operation is less than or equal to the preset threshold value;

(v) if the sum of the monetary amounts of all products in the second group of product information is less than or equal to the preset threshold value, generate a piece of invoice information that comprises the monetary amount and the name of each product in the second group of product information.

Optionally, the first invoice information generating unit is specifically configured to:

sort the information of all the products according to a descending order of the monetary amount of each product, and group the information of all the products according to the sorting result and a preset threshold value to obtain a first group of product information and a second group of product information, wherein the monetary amount of each product in the first group of product information is greater than or equal to the preset threshold value, and the monetary amount of each product in the second group of product information is less than the preset threshold value.

### BRIEF DESCRIPTION OF THE DRAWINGS

FIG. 1 is a flow chart of an invoice information determining method according to embodiments of the present invention;

FIG. 2 is a flow chart of another invoice information determining method according to embodiments of the present invention;

FIG. 3 is a flow chart of an information processing method according to embodiments of the present invention;

FIG. 4 is a schematic structural diagram of an invoice information determining device according to embodiments of the present invention;

FIG. 5 is a schematic structural diagram of an information processing device according to embodiments of the present invention.

### DETAILED DESCRIPTION

Embodiments of the present application provide a method and a device for processing information and determining invoice information to have a minimal number of product types on each invoice while ensuring a minimal number of invoices, thus facilitating a user to check product items against an invoice and improving work efficiency.

The technical solutions according to embodiments of the present application keep invoices to be simple to greatly facilitate the improvement of work efficiency in a subsequent process that a user checks product items against an invoice.

The technical solutions according to embodiments of the present application will be described below with reference to the accompanying drawings.

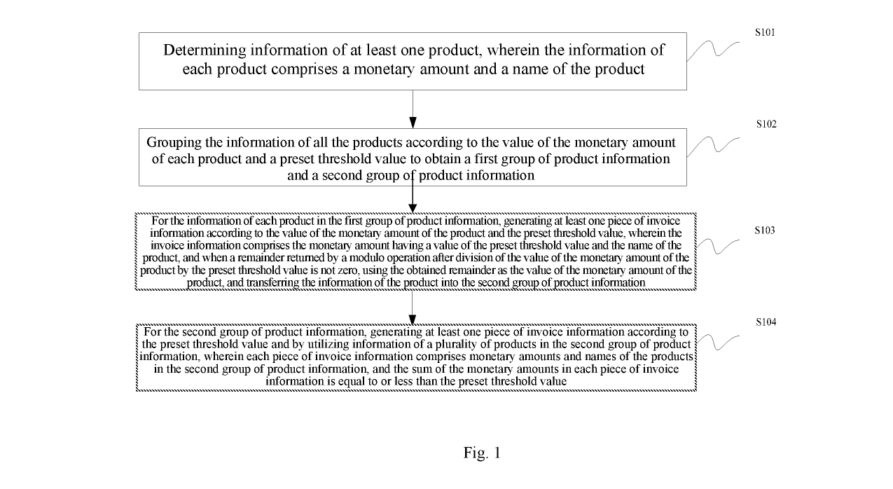

Referring to FIG. 1, an invoice information determining method according to embodiments of the present application comprises:

S101. Determining information of at least one product, wherein the information of each product comprises a monetary amount and a name of the product;

The information of each product may further comprise other information than the monetary amount and the name of the product.

S102. Grouping the information of all the products according to the value of the monetary amount of each product and a preset threshold value to obtain a first group of product information and a second group of product information.

For example, the preset threshold value is 10,000, i.e. the maximal value of the sum of monetary amounts of all products on one single invoice. The information of products having a monetary amount greater than 10,000 is classified into the first group of product information; and the information of products having a monetary amount less than 10,000 is classified into the second group of product information.

S103. For the information of each product in the first group of product information, generating at least one piece of invoice information according to the value of the monetary amount of the product and the preset threshold value, wherein the invoice information comprises the monetary amount having a value of the preset threshold value and the name of the product, and when a remainder returned by a modulo operation after division of the value of the monetary amount of the product by the preset threshold value is not zero, using the obtained remainder as the value of the monetary amount of the product, and transferring the information of the product into the second group of product information.

For example, the monetary amount of a product A is 35,000 Yuan, while the maximum invoicing limit of a single invoice is 10,000, then 3 invoices are issued for the product A with the limit being 10,000 for each invoice. The remaining 5,000 is used as the monetary amount of the product A and transferred into the second group of product information.

S104. For the second group of product information, generating at least one piece of invoice information according to the preset threshold value and by utilizing information of a plurality of products in the second group of product information, wherein each piece of invoice information comprises monetary amounts and names of the plurality of products in the second group of product information, and the sum of the monetary amounts of the plurality of products is equal to or less than the preset threshold value.

It should be noted that, in addition to monetary amounts and names of the products, the invoice information set forth in embodiments of the present invention may further comprise other information of an invoice, such as payable to, the organization that issues the invoice, and total monetary amount of the invoice.

Optionally, the generating at least one piece of invoice information according to the preset threshold value and by utilizing information of a plurality of products in the second group of product information comprises:

if the sum of the monetary amounts of all products in the second group of product information is greater than the preset threshold value, sequentially reading the value of the monetary amount of each product in the second group of product information, and performing current accumulation; when the obtained sum is greater than or equal to the preset threshold value, generating invoice information corresponding to the current accumulation operation, the invoice information comprising monetary amounts and names of the plurality of products that participate in the current accumulation operation, and the sum of the monetary amounts of the plurality of products being equal to the preset threshold value; here, when the obtained sum is greater than the preset threshold value, dividing the value of the monetary amount of the last product in the current accumulation operation, one part of which is used in the current accumulation operation, such that the obtained sum reaches the preset threshold value, and the other part of which is used as the value of the monetary amount of the last accumulated product to participate in the next accumulation; and so on and so forth until the value of the monetary amount of each product in the second group of product information has been accumulated; here, the value of the monetary amount comprised in the invoice information corresponding to the last accumulation operation is less than or equal to the preset threshold value.

For example, the current second group of product information comprises information of 3 products, and the total monetary amount of these products is greater than 10,000, e.g. 15,000, wherein the monetary amount of a product A is 8,000, the monetary amount of a product B is 3,000 and the monetary amount of a product C is 4,000. Then, the monetary amount of the product A and the monetary amount of the product B are added first to obtain a sum of 11,000. The monetary amount of the product B is divided into two parts, 2,000 and 1,000, wherein the part of 2,000 is accumulated to the monetary amount of the product A to form one piece of invoice information comprising the monetary amount of the product A that is 8,000 and the monetary amount of the product B that is 2,000; the next accumulation is then performed, i.e. the monetary amount of the product B that is 1,000 and the monetary amount of the product C that is 4,000 are accumulated to obtain one piece of invoice information comprising the monetary amount of the product B that is 1,000 and the monetary amount of the product C that is 4.

If the sum of the monetary amounts of all products in the second group of product information is less than or equal to the preset threshold value, generating a piece of invoice information that comprises the monetary amount and the name of each product in the second group of product information.

For example, the current second group of product information comprises information of 3 products, and the total monetary amount of these products is less than 10,000, e.g. 8,000, wherein the monetary amount of a product A is 2,000, the monetary amount of a product B is 3,000 and the monetary amount of a product C is 3,000. Then, one piece of invoice information is generated to comprise the monetary amount and the name of each product in the second group of product information.

Optionally, the grouping the information of all the products according to the value of the monetary amount of each product and a preset threshold value to obtain a first group of product information and a second group of product information comprises:

sorting the information of all the products according to a descending order of the monetary amount of each product, and grouping the information of all the products according to the sorting result and a preset threshold value to obtain a first group of product information and a second group of product information, wherein the monetary amount of each product in the first group of product information is greater than or equal to the preset threshold value, and the monetary amount of each product in the second group of product information is less than the preset threshold value.

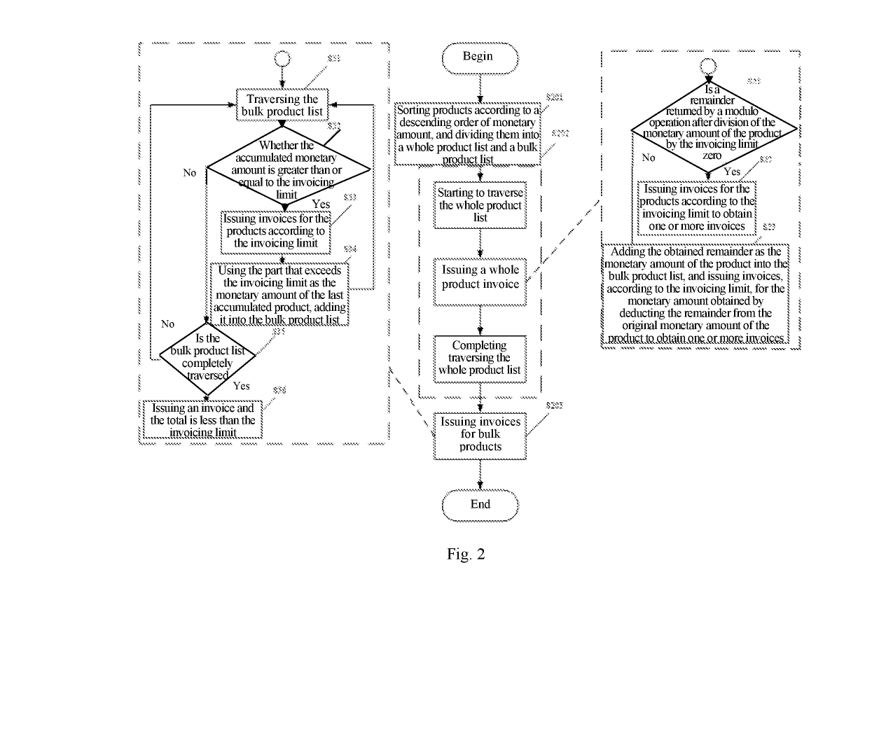

Referring to FIG. 2, an invoice information determining method according to embodiments of the present invention specifically comprises:

S201. Sorting products according to a descending order of monetary amount, and dividing them into a whole product list and a bulk product list.

Here, the whole product list contains information of products having a monetary amount greater than or equal to an invoicing limit. The bulk product list contains information of products having a monetary amount less than the invoicing limit. The invoicing limit is the maximal total monetary amount of a single invoice.

S202. Starting to traverse the whole product list, and issuing a whole product invoice for each product until the whole product list is completely traversed, wherein each invoice comprises the information of only one product.

Herein, the issuing a whole product invoice for each product specifically comprises:

S21. Determining whether a remainder returned by a modulo operation after division of the monetary amount of the product by the invoicing limit is zero. If yes, go to the step S22; otherwise, go to the step S23.

S22. Issuing invoices for the products according to the invoicing limit to obtain one or more invoices.

S23. Adding the obtained remainder as the monetary amount of the product into the bulk product list, and issuing invoices, according to the invoicing limit, for the monetary amount obtained by deducting the remainder from the original monetary amount of the product to obtain one or more invoices.

S203. Issuing invoices for bulk products, namely traversing the bulk product list, and accumulating bulk products according to the invoicing limit. If the total monetary amount is greater than the invoicing limit after a bulk product is added, then the bulk product needs to be divided, and the remaining part is thrown into the bulk product list as the first bulk product for next accumulation; lastly, one invoice is issued for the bulk product list that has a total less than the invoicing limit.

The step S203 specifically comprises:

S31. Traversing the bulk product list.

S32. Determining whether the accumulated monetary amount is greater than or equal to the invoicing limit. If yes, go to the step S33; otherwise, go to the step S35.

S33. Issuing invoices for the products according to the invoicing limit.

S34. Using the part that exceeds the invoicing limit as the monetary amount of the last accumulated product, adding it into the bulk product list, and continuing to execute the step S31, namely continuing to traverse the bulk product list.

S35. Determining whether the bulk product list is completely traversed. If yes, go to the step S36; otherwise, go to the step S31, namely continuing to traverse the bulk product list.

S36. Issuing an invoice and the total is less than the invoicing limit.

The above solution according to embodiments of the present invention minimizes the product types on one single invoice and improves the operating efficiency of a client;

Referring to Table 2 below, the invoice information obtained by using the technical solution according to embodiments of the present invention is simpler than that from invoices issued with the prior art set forth in the Background:

TABLE 2

| Invoice serial number | Product name and amount |
|---|---|
| 1 | Product A: 10,000; |
| 2 | Product A: 10,000; |
| 3 | Product B: 10,000; |
| 4 | Product A: 8,000; |
| | Product C: 2,000; |
| 5 | Product C: 3,000; |

The above description only uses invoice information determination as an example, and the present invention is not limited to this type of applications.

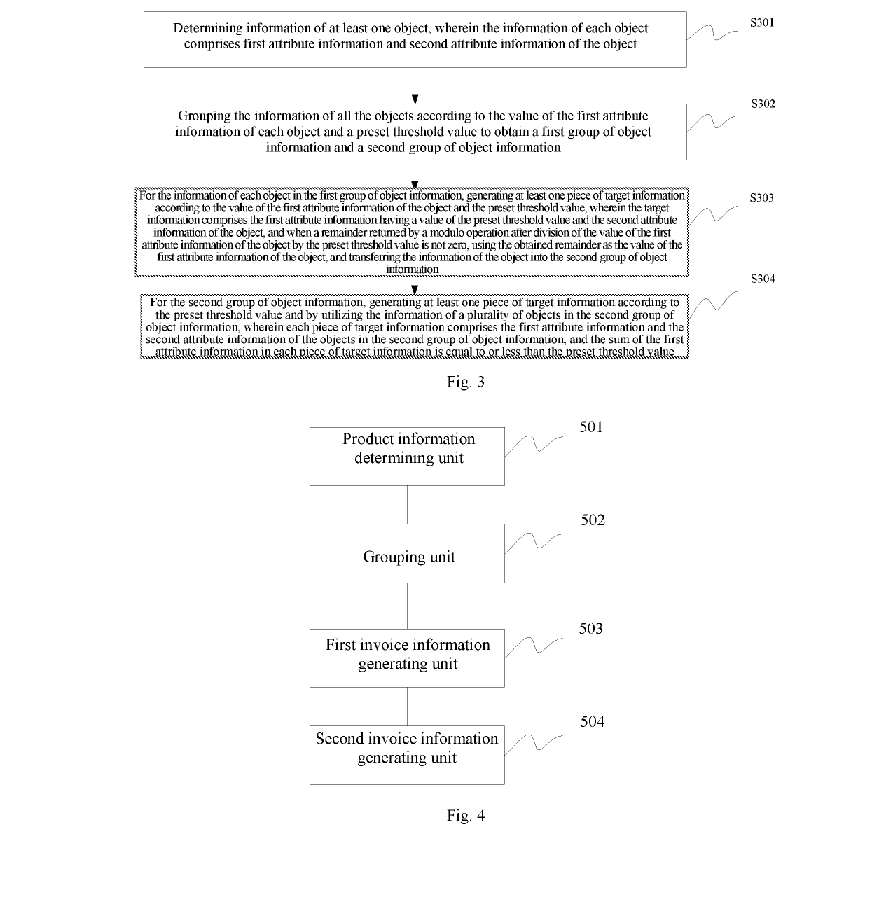

Referring to FIG. 3, an information processing method according to embodiments of the present invention comprises:

S301. Determining information of at least one object, wherein the information of each object comprises first attribute information and second attribute information of the object.

Here, the object is, for example, a product; the first attribute information is, for example, a monetary amount of the product; and the second attribute information is, for example, a name of the product.

S302. Grouping the information of all the objects according to the value of the first attribute information of each object and a preset threshold value to obtain a first group of object information and a second group of object information.

Here, the first group of object information is, for example, information of products with a monetary amount more than 10,000.

S303. For the information of each object in the first group of object information, generating at least one piece of target information according to the value of the first attribute information of the object and the preset threshold value, wherein the target information comprises the first attribute information having a value of the preset threshold value and the second attribute information of the object, and when a remainder returned by a modulo operation after division of the value of the first attribute information of the object by the preset threshold value is not zero, using the obtained remainder as the value of the first attribute information of the object, and transferring the information of the object into the second group of object information;

Here, the target information is, for example, information of an invoice.

S304. For the second group of object information, generating at least one piece of target information according to the preset threshold value and by utilizing the information of a plurality of objects in the second group of object information, wherein each piece of target information comprises the first attribute information and the second attribute information of the plurality of objects in the second group of object information, and the sum of the first attribute information of the plurality of objects is equal to or less than the preset threshold value.

Optionally, the generating at least one piece of target information according to the preset threshold value and by utilizing the information of a plurality of objects in the second group of object information comprises:

if the sum of values of the first attribute information of all objects in the second group of object information is greater than the preset threshold value, sequentially reading the value of the first attribute information of each object in the second group of object information, and performing current accumulation; when the obtained sum is greater than or equal to the preset threshold value, generating target information corresponding to the current accumulation operation, the target information comprising the first attribute information and the second attribute information of the plurality of objects that participate in the current accumulation operation, and the sum of the first attribute information of the plurality of objects that participate in the current accumulation operation being equal to the preset threshold value; here, when the obtained sum is greater than the preset threshold value, dividing the value of the first attribute information of the last object in the current accumulation operation, one part of which is used in the current accumulation operation as the value of the first attribute information of the last object in the current accumulation operation, such that the obtained sum reaches the preset threshold value, and the other part of which is used as the value of the first attribute information of the last accumulated object to participate in the next accumulation; and so on and so forth until the value of the first attribute information of each object in the second group of object information has been accumulated; here, the sum of values of the first attribute information of the objects comprised in the target information corresponding to the last accumulation operation is less than or equal to the preset threshold value;

if the sum of values of the first attribute information of all objects in the second group of object information is less than or equal to the preset threshold value, generating a piece of target information that comprises the first attribute information and the second attribute information of each object in the second group of object information.

Optionally, the grouping the information of all the objects according to the value of the first attribute information of each object and a preset threshold value to obtain a first group of object information and a second group of object information comprises:

sorting the information of all the objects according to a descending order of the value of the first attribute information of each object, and grouping the information of all the objects according to the sorting result and a preset threshold value to obtain a first group of object information and a second group of object information, wherein the value of the first attribute information of each object in the first group of object information is greater than or equal to the preset threshold value, and the value of the first attribute information of each object in the second group of object information is less than the preset threshold value.

Corresponding to the above method, referring to FIG. 4, an invoice information determining device according to embodiments of the present invention comprises:

a product information determining unit 501 configured to determine information of at least one product, wherein the information of each product comprises a monetary amount and a name of the product;

a grouping unit 502 configured to group the information of all the products according to the value of the monetary amount of each product and a preset threshold value to obtain a first group of product information and a second group of product information;

a first invoice information generating unit 503 configured to, for the information of each product in the first group of product information, generate at least one piece of invoice information according to the value of the monetary amount of the product and the preset threshold value, wherein the invoice information comprises the monetary amount having a value of the preset threshold value and the name of the product, and when a remainder returned by a modulo operation after division of the value of the monetary amount of the product by the preset threshold value is not zero, use the obtained remainder as the value of the monetary amount of the product, and transfer the information of the product into the second group of product information;

a second invoice information generating unit 504 configured to, for the second group of product information, generate at least one piece of invoice information according to the preset threshold value and by utilizing information of a plurality of products in the second group of product information, wherein each piece of invoice information comprises monetary amounts and names of the plurality of products in the second group of product information, and the sum of the monetary amounts of the plurality of products is equal to or less than the preset threshold value.

Optionally, the second invoice information generating unit that generates at least one piece of invoice information according to the preset threshold value and by utilizing information of a plurality of products in the second group of product information is specifically configured to:

if the sum of the monetary amounts of all products in the second group of product information is greater than the preset threshold value, sequentially read the value of the monetary amount of each product in the second group of product information, and perform current accumulation; when the obtained sum is greater than or equal to the preset threshold value, generate invoice information corresponding to the current accumulation operation, the invoice information comprising monetary amounts and names of the plurality of products that participate in the current accumulation operation, and the sum of the monetary amounts of the plurality of products being equal to the preset threshold value; here, when the obtained sum is greater than the preset threshold value, divide the value of the monetary amount of the last product in the current accumulation operation, one part of which is used in the current accumulation operation, such that the obtained sum reaches the preset threshold value, and the other part of which is used as the value of the monetary amount of the last accumulated product to participate in the next accumulation; and so on and so forth until the value of the monetary amount of each product in the second group of product information has been accumulated; here, the value of the monetary amount comprised in the invoice information corresponding to the last accumulation operation is less than or equal to the preset threshold value;

if the sum of the monetary amounts of all products in the second group of product information is less than or equal to the preset threshold value, generate a piece of invoice information that comprises the monetary amount and the name of each product in the second group of product information.

Optionally, the first invoice information generating unit is specifically configured to:

sort the information of all the products according to a descending order of the monetary amount of each product, and group the information of all the products according to the sorting result and a preset threshold value to obtain a first group of product information and a second group of product information, wherein the monetary amount of each product in the first group of product information is greater than or equal to the preset threshold value, and the monetary amount of each product in the second group of product information is less than the preset threshold value.

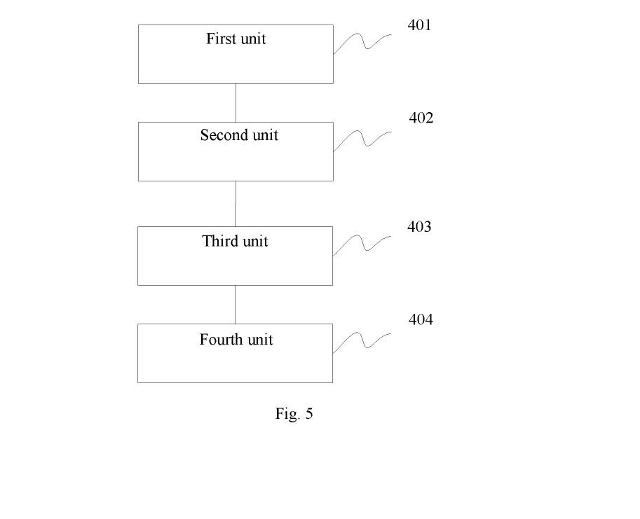

Referring to FIG. 5, an information processing device according to embodiments of the present invention comprises:

a first unit 401 configured to determine information of at least one object, wherein the information of each object comprises first attribute information and second attribute information of the object;

a second unit 402 configured to group the information of all the objects according to the value of the first attribute information of each object and a preset threshold value to obtain a first group of object information and a second group of object information;

a third unit 403 configured to, for the information of each object in the first group of object information, generate at least one piece of target information according to the value of the first attribute information of the object and the preset threshold value, wherein the target information comprises the first attribute information having a value of the preset threshold value and the second attribute information of the object, and when a remainder returned by a modulo operation after division of the value of the first attribute information of the object by the preset threshold value is not zero, use the obtained remainder as the value of the first attribute information of the object, and transfer the information of the object into the second group of object information;

a fourth unit 404 configured to, for the second group of object information, generate at least one piece of target information according to the preset threshold value and by utilizing the information of a plurality of objects in the second group of object information, wherein each piece of target information comprises the first attribute information and the second attribute information of the plurality of objects in the second group of object information, and the sum of the first attribute information of the plurality of objects is equal to or less than the preset threshold value.

Optionally, the fourth unit that generates at least one piece of target information according to the preset threshold value and by utilizing the information of a plurality of objects in the second group of object information is specifically configured to:

if the sum of values of the first attribute information of all objects in the second group of object information is greater than the preset threshold value, sequentially read the value of the first attribute information of each object in the second group of object information, and perform current accumulation; when the obtained sum is greater than or equal to the preset threshold value, generate target information corresponding to the current accumulation operation, the target information comprising the first attribute information and the second attribute information of the plurality of objects that participate in the current accumulation operation, and the sum of the first attribute information of the plurality of objects that participate in the current accumulation operation being equal to the preset threshold value; here, when the obtained sum is greater than the preset threshold value, divide the value of the first attribute information of the last object in the current accumulation operation, one part of which is used in the current accumulation operation as the value of the first attribute information of the last object in the current accumulation operation, such that the obtained sum reaches the preset threshold value, and the other part of which is used as the value of the first attribute information of the last accumulated object to participate in the next accumulation; and so on and so forth until the value of the first attribute information of each object in the second group of object information has been accumulated; here, the sum of values of the first attribute information of the objects comprised in the target information corresponding to the last accumulation operation is less than or equal to the preset threshold value;

if the sum of values of the first attribute information of all objects in the second group of object information is less than or equal to the preset threshold value, generate a piece of target information that comprises the first attribute information and the second attribute information of each object in the second group of object information.

Optionally, the second unit is specifically configured to:

sort the information of all the objects according to a descending order of the value of the first attribute information of each object, and group the information of all the objects according to the sorting result and a preset threshold value to obtain a first group of object information and a second group of object information, wherein the value of the first attribute information of each object in the first group of object information is greater than or equal to the preset threshold value, and the value of the first attribute information of each object in the second group of object information is less than the preset threshold value.

The units set forth in the above embodiments of the present invention may all be implemented by physical modules, such as processors.

In summary, when invoice information is determined by using the technical solution according to embodiments of the present invention, the number of invoices is minimized and a client's cost is reduced; as a result, the number of product types on a single invoice is minimized, thereby making it easier for a user to check product items against an invoice.

Those skilled in the art should understand that the embodiments of the present invention may be provided as a method, a system, or a computer program product. Therefore, the present invention may be implemented as a complete hardware embodiment, a complete software embodiment, or an embodiment combing software and hardware. Moreover, the present invention may be a computer program product implemented on one or more computer usable storage media (including, but not limited to, a magnetic disk memory, an optical memory, and the like) including computer usable program codes.

The present invention is described with reference to flowcharts and/or block diagrams of the method, device (system) and computer program product according to the embodiments of the present invention. It should be understood that a computer program instruction may be used to implement each process and/or block in the flowcharts and/or block diagrams and a combination of processes and/or blocks in the flowcharts and/or block diagrams. These computer program instructions may be provided for a general-purpose computer, a special-purpose computer, an embedded processor, or a processor of other programmable data processing devices to generate a machine, so that the instructions executed by a computer or a processor of other programmable data processing devices generate an apparatus for implementing a specified function in one or more processes in the flowcharts and/or in one or more blocks in the block diagrams.

These computer program instructions may also be stored in a computer readable memory that can instruct a computer or other programmable data processing devices to work in a particular manner, such that the instructions stored in the computer readable memory generate a manufactured article that includes an instruction apparatus. The instruction apparatus implements a specified function in one or more processes in the flowcharts and/or in one or more blocks in the block diagrams.

These computer program instructions may also be loaded onto a computer or other programmable data processing devices, such that a series of operational steps are performed on the computer or other programmable devices, thereby generating computer-implemented processing. Therefore, the instructions executed on the computer or other programmable devices provide steps for implementing a specified function in one or more processes in the flowcharts and/or in one or more blocks in the block diagrams.

Obviously, those skilled in the art can make various modifications and variations without departing from the spirit and scope of the present application. In such a way, if these modifications and variations of the present application fall in the scope of the claims of the present application and equivalent technologies thereof, the present application also intends to encompass these modifications and variations.

1. An information processing method, implemented by a processor, comprising:
determining information of at least one object, wherein the information of the at least one object comprises first attribute information and second attribute information of the object;
grouping the information of all the objects according to the value of the first attribute information of each object and a preset threshold value to obtain a first group of object information and a second group of object information;
for the information of each object in the first group of object information, generating at least one piece of target information according to the value of the first attribute information of the object and the preset threshold value, wherein the target information comprises the first attribute information having a value of the preset threshold value and the second attribute information of the object, and when a remainder returned by a modulo operation after division of the value of the first attribute information of the object by the preset threshold value is not zero, using the obtained remainder as the value of the first attribute information of the object, and transferring the information of the object into the second group of object information;
for the second group of object information, generating at least one piece of target information according to the preset threshold value and by utilizing the information of a plurality of objects in the second group of object information, wherein each piece of target information comprises the first attribute information and the second attribute information of the objects in the second group of object information, and the sum of the first attribute information in each piece of target information is equal to or less than the preset threshold value.

2. The method according to claim 1, wherein the generating at least one piece of target information according to the preset threshold value and by utilizing the information of a plurality of objects in the second group of object information comprises:
(i) if the sum of values of the first attribute information of all objects in the second group of object information is greater than the preset threshold value, sequentially reading the value of the first attribute information of each object in the second group of object information, and performing current accumulation;
(ii) when the obtained sum reaches the preset threshold value, generating target information corresponding to the current accumulation operation, the target information comprising the first attribute information and the second attribute information of the objects that participate in the current accumulation operation, and the sum of the first attribute information of the objects that participate in the current accumulation operation being equal to the preset threshold value, and
(iii) if the obtained sum is greater than the preset threshold value, dividing the value of the first attribute information of the last object in the current accumulation operation, one part of which is used in the current accumulation operation as the value of the first attribute information of the last object in the current accumulation operation, such that the obtained sum reaches the preset threshold value, and the other part of which is used as the value of the first attribute information of the last accumulated object to participate in the next accumulation; and
(iv) repeating (ii) and (iii) until the value of the first attribute information of each object in the second group of object information has been accumulated, wherein the sum of values of the first attribute information of the objects comprised in the target information corresponding to the last accumulation operation is less than or equal to the preset threshold value;
(v) if the sum of values of the first attribute information of all objects in the second group of object information is less than or equal to the preset threshold value, generating a piece of target information that comprises the first attribute information and the second attribute information of each object in the second group of object information.

3. The method according to claim 1, wherein the grouping the information of all the objects according to the value of the first attribute information of each object and a preset threshold value to obtain a first group of object information and a second group of object information comprises:
sorting the information of all the objects according to a descending order of the value of the first attribute information of each object, and grouping the information of all the objects according to the sorting result and a preset threshold value to obtain a first group of object information and a second group of object information, wherein the value of the first attribute information of each object in the first group of object information is greater than or equal to the preset threshold value, and the value of the first attribute information of each object in the second group of object information is less than the preset threshold value.

4. An invoice information determining method, implemented by a processor, comprising:
determining information of at least one product, wherein the information of each product comprises a monetary amount and a name of the product;
grouping the information of all the products according to the value of the monetary amount of each product and a preset threshold value to obtain a first group of product information and a second group of product information;
for the information of each product in the first group of product information, generating at least one piece of invoice information according to the value of the monetary amount of the product and the preset threshold value, wherein the invoice information comprises the monetary amount having a value of the preset threshold value and the name of the product, and when a remainder returned by a modulo operation after division of the value of the monetary amount of the product by the preset threshold value is not zero, using the obtained remainder as the value of the monetary amount of the product, and transferring the information of the product into the second group of product information;
for the second group of product information, generating at least one piece of invoice information according to the preset threshold value and by utilizing information of a plurality of products in the second group of product information, wherein each piece of invoice information comprises monetary amounts and names of the products in the second group of product information, and the sum of the monetary amounts in each piece of invoice information is equal to or less than the preset threshold value.

5. The method according to claim 4, wherein the generating at least one piece of invoice information according to the preset threshold value and by utilizing information of a plurality of products in the second group of product information comprises:
(i) if the sum of the monetary amounts of all products in the second group of product information is greater than the preset threshold value, sequentially reading the value of the monetary amount of each product in the second group of product information, and performing current accumulation;
(ii) when the obtained sum reaches the preset threshold value, generating invoice information corresponding to the current accumulation operation, the invoice information comprising monetary amounts and names of the plurality of products that participate in the current accumulation operation, and the sum of the monetary amounts of the plurality of products being equal to the preset threshold value;
(iii) when the obtained sum is greater than the preset threshold value, dividing the value of the monetary amount of the last product in the current accumulation operation, one part of which is used in the current accumulation operation, such that the obtained sum reaches the preset threshold value, and the other part of which is used as the value of the monetary amount of the last accumulated product to participate in the next accumulation; and
(iv) repeating (ii) and (iii) until the value of the monetary amount of each product in the second group of product information has been accumulated, wherein the value of the monetary amount comprised in the invoice information corresponding to the last accumulation operation is less than or equal to the preset threshold value;
(v) if the sum of the monetary amounts of all products in the second group of product information is less than or equal to the preset threshold value, generating a piece of invoice information that comprises the monetary amount and the name of each product in the second group of product information.

6. The method according to claim 4, wherein the grouping the information of all the products according to the value of the monetary amount of each product and a preset threshold value to obtain a first group of product information and a second group of product information comprises:
sorting the information of all the products according to a descending order of the monetary amount of each product, and grouping the information of all the products according to the sorting result and a preset threshold value to obtain a first group of product information and a second group of product information, wherein the monetary amount of each product in the first group of product information is greater than or equal to the preset threshold value, and the monetary amount of each product in the second group of product information is less than the preset threshold value.

7. An information processing device, comprising:
a first unit configured to determine information of at least one object, wherein the information of each object comprises first attribute information and second attribute information of the object;
a second unit configured to group the information of all the objects according to the value of the first attribute information of each object and a preset threshold value to obtain a first group of object information and a second group of object information;
a third unit configured to, for the information of each object in the first group of object information, generate at least one piece of target information according to the value of the first attribute information of the object and the preset threshold value, wherein the target information comprises the first attribute information having a value of the preset threshold value and the second attribute information of the object, and when a remainder returned by a modulo operation after division of the value of the first attribute information of the object by the preset threshold value is not zero, use the obtained remainder as the value of the first attribute information of the object, and transfer the information of the object into the second group of object information;
a fourth unit configured to, for the second group of object information, generate at least one piece of target information according to the preset threshold value and by utilizing the information of a plurality of objects in the second group of object information, wherein each piece of target information comprises the first attribute information and the second attribute information of the objects in the second group of object information, and the sum of the first attribute information in each piece of target information is equal to or less than the preset threshold value.

8. The device according to claim 7, wherein the fourth unit that generates at least one piece of target information according to the preset threshold value and by utilizing the information of a plurality of objects in the second group of object information is further configured to:
(i) if the sum of values of the first attribute information of all objects in the second group of object information is greater than the preset threshold value, sequentially read the value of the first attribute information of each object in the second group of object information, and perform current accumulation;
(ii) when the obtained sum reaches the preset threshold value, generate target information corresponding to the current accumulation operation, the target information comprising the first attribute information and the second attribute information of the plurality of objects that participate in the current accumulation operation, and the sum of the first attribute information of the plurality of objects that participate in the current accumulation operation being equal to the preset threshold value;
(iii) when the obtained sum is greater than the preset threshold value, divide the value of the first attribute information of the last object in the current accumulation operation, one part of which is used in the current accumulation operation as the value of the first attribute information of the last object in the current accumulation operation, such that the obtained sum reaches the preset threshold value, and the other part of which is used as the value of the first attribute information of the last accumulated object to participate in the next accumulation; and
(iv) repeat (ii) and (iii) until the value of the first attribute information of each object in the second group of object information has been accumulated, wherein the sum of values of the first attribute information of the objects comprised in the target information corresponding to the last accumulation operation is less than or equal to the preset threshold value;
(v) if the sum of values of the first attribute information of all objects in the second group of object information is less than or equal to the preset threshold value, generate a piece of target information that comprises the first attribute information and the second attribute information of each object in the second group of object information.

9. The device according to claim 7, wherein the second unit is configured to:
sort the information of all the objects according to a descending order of the value of the first attribute information of each object, and group the information of all the objects according to the sorting result and a preset threshold value to obtain a first group of object information and a second group of object information, wherein the value of the first attribute information of each object in the first group of object information is greater than or equal to the preset threshold value, and the value of the first attribute information of each object in the second group of object information is less than the preset threshold value.

10. An invoice information determining device, comprising:
a product information determining unit configured to determine information of at least one product, wherein the information of each product comprises a monetary amount and a name of the product;
a grouping unit configured to group the information of all the products according to the value of the monetary amount of each product and a preset threshold value to obtain a first group of product information and a second group of product information;
a first invoice information generating unit configured to, for the information of each product in the first group of product information, generate at least one piece of invoice information according to the value of the monetary amount of the product and the preset threshold value, wherein the invoice information comprises the monetary amount having a value of the preset threshold value and the name of the product, and when a remainder returned by a modulo operation after division of the value of the monetary amount of the product by the preset threshold value is not zero, use the obtained remainder as the value of the monetary amount of the product, and transfer the information of the product into the second group of product information;
a second invoice information generating unit configured to, for the second group of product information, generate at least one piece of invoice information according to the preset threshold value and by utilizing information of a plurality of products in the second group of product information, wherein each piece of invoice information comprises monetary amounts and names of the products in the second group of product information, and the sum of the monetary amounts in each piece of invoice information is equal to or less than the preset threshold value.

11. The device according to claim 10, wherein the second invoice information generating unit that generates at least one piece of invoice information according to the preset threshold value and by utilizing information of a plurality of products in the second group of product information is further configured to:
(i) if the sum of the monetary amounts of all products in the second group of product information is greater than the preset threshold value, sequentially read the value of the monetary amount of each product in the second group of product information, and perform current accumulation;
(ii) when the obtained sum is greater than or equal to the preset threshold value, generate invoice information corresponding to the current accumulation operation, the invoice information comprising monetary amounts and names of the plurality of products that participate in the current accumulation operation, and the sum of the monetary amounts of the plurality of products being equal to the preset threshold value;
(iii) when the obtained sum is greater than the preset threshold value, divide the value of the monetary amount of the last product in the current accumulation operation, one part of which is used in the current accumulation operation, such that the obtained sum reaches the preset threshold value, and the other part of which is used as the value of the monetary amount of the last accumulated product to participate in the next accumulation; and
(iv) repeat (ii) and (iii) until the value of the monetary amount of each product in the second group of product information has been accumulated, wherein the value of the monetary amount comprised in the invoice information corresponding to the last accumulation operation is less than or equal to the preset threshold value;
(v) if the sum of the monetary amounts of all products in the second group of product information is less than or equal to the preset threshold value, generate a piece of invoice information that comprises the monetary amount and the name of each product in the second group of product information.

12. The device according to claim 10, wherein the first invoice information generating unit is configured to:
sort the information of all the products according to a descending order of the monetary amount of each product, and group the information of all the products according to the sorting result and a preset threshold value to obtain a first group of product information and a second group of product information, wherein the monetary amount of each product in the first group of product information is greater than or equal to the preset threshold value, and the monetary amount of each product in the second group of product information is less than the preset threshold value.
